(19) United States
(12) Patent Application Publication
(10) Pub. No.: US 2005/0188384 A1
(43) Pub. Date: Aug. 25, 2005

(54) Electronic content processing systems and methods

(76) Inventors: Kumanan Yogaratnam, Ottawa (CA); Dat Doan, Kanata (CA)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 10/784,280

(22) Filed: Feb. 24, 2004

(51) Int. Cl. G06F 9/46

(52) U.S. Cl. 719/331

(57) ABSTRACT

Dynamic electronic content processing systems and methods are provided. An internal software module defines at least one internal software element, and respective registries are provided for software modules and different types of externally defined software elements. Electronic content is processed by the internal software module to resolve embedded references in the content to internal and external software elements. A handle associated with the electronic content is supplied during the processing to resolve the embedded references to external software elements. The electronic content is then accessible to software code supporting the external software elements using the handle. In another embodiment of the invention, software modules are notified of processing of the electronic content, and the content is thereby made accessible to the software modules.

### FIELD OF THE INVENTION

This invention relates to information processing, and in particular to processing electronic content.

### BACKGROUND

In many electronic systems and processing environments, application-specific products are normally provided as so-called “monolithic” systems. A manufacturer or provider adapts a product for each customer, and products adapted for one particular customer are rarely, if ever, usable by other customers that have different processing requirements or goals, or even by the same customer for different end products, without significant re-engineering.

From a manufacturer point of view, these design techniques are labor intensive, requiring substantial system redesign each time a different set of functions is to be supported. Providing customer support for a number of such different systems may also involve significant resources and costs.

For customers, the development of specialized processing systems tends to increase costs relative to implementation of off-the-shelf solutions. Once the design process has begun, it may also be difficult to change an initial set of specifications or requirements. Furthermore, these types of systems are not typically adaptable, at least at a functional level. Modification of supported functions is normally a manufacturer or software provider task that cannot be performed by a customer.

As those skilled in the art will appreciate, custom software systems often create portability issues for electronic content that is intended to operate in conjunction with such systems. Content designed for one particular custom processing system cannot simply be installed on and executed by another custom processing system.

### SUMMARY OF THE INVENTION

According to one aspect of the invention, a method of processing electronic content comprises providing an internal software module defining at least one internal software element, providing a plurality of respective registries for different types of software elements, the plurality of respective registries comprising a software element registry for external software elements, and processing electronic content using the internal software module to resolve embedded references in the electronic content to the internal software elements and embedded references in the electronic content to any external software elements in the software element registry. The external software elements in the software element registry comprise at least one external software element supported by software code, and processing to resolve embedded references in the electronic content to the at least one external software element comprises supplying a handle associated with the electronic content. The electronic content is accessible to the software code using the handle.

In another aspect, the invention provides a method of processing electronic content comprising providing an internal software module defining embeddable software elements, providing an external software module, processing the electronic content using the internal software module to resolve embedded references in the electronic content to the embeddable software elements, notifying the external software module of the processing of the electronic content, and accessing the electronic content by the external software module responsive to the notifying.

The invention also provides, in another aspect, a system comprising a plurality of software element managers, each software element manager maintaining a respective registry of software elements of a predetermined type, the plurality of software element managers comprising an embeddable software element manager maintaining a registry of embeddable externally defined software elements, and an electronic content loader defining embeddable internal software elements, configured to receive electronic content, to resolve references in the electronic content to the embeddable internal software elements, and to resolve references in the electronic content to any embeddable external software elements in the registry of the embeddable software element manager. The embeddable external software elements in the registry of the embeddable software element manager comprise at least one embeddable external software element supported by software code, and the electronic content loader is further configured to resolve the references in the electronic content to the at least one embeddable external software element by supplying a handle associated with the electronic content. The electronic content is accessible to the software code using the handle.

A system according to a further aspect of the invention comprises an internal software module defining embeddable software elements and configured to process electronic content by resolving references in the electronic content to the embeddable software elements, and an external software module configured to detect the processing of the electronic content and to access the electronic content responsive to the detection.

In a still further aspect, the invention provides an electronic device having a processor and a computer-readable medium accessible by the processor. The medium stores instructions which when executed by the processor perform a method comprising providing an internal software module defining an embeddable internal software element, providing a plurality of respective registries for different types of software elements, the plurality of respective registries comprising an embeddable software element registry for an externally defined embeddable external software element, processing electronic content using the internal software module to resolve any embedded references in the electronic content to the embeddable internal software element and any embedded references in the electronic content to the embeddable external software element in the embeddable software element registry, providing an external software module, detecting the processing of the electronic content, and providing access to the electronic content by the external software module.

In yet another broad aspect, the invention provides a system comprising means for providing an internal software module defining an embeddable internal software element, means for providing a plurality of respective registries for different types of software elements, the plurality of respective registries comprising an embeddable software element registry for an externally defined embeddable external software element, means for processing electronic content using the internal software module to resolve any embedded references in the electronic content to the embeddable internal software element and any embedded references in the electronic content to the embeddable external software element in the embeddable software element registry, means for providing an external software module, means for detecting the processing of the electronic content, and means for providing access to the electronic content by the external software module.

In a preferred embodiment, the embeddable external software element is supported by software code, processing electronic content to resolve any embedded references in the electronic content to the embeddable external software element comprises supplying a handle associated with the electronic content, and the electronic content is accessible to the software code using the handle.

Other aspects and features of embodiments of the present invention will become apparent to those ordinarily skilled in the art upon review of the following description of the specific embodiments of the invention.

### BRIEF DESCRIPTION OF THE DRAWINGS

Embodiments of the invention will now be described in greater detail with reference to the accompanying diagrams, in which:

FIG. 1 is a block diagram of an example processing system in which the present invention may be implemented;

FIG. 2 is a block diagram of a system according to an embodiment of the invention;

FIG. 3 is a block diagram of a system according to a further embodiment of the invention;

FIG. 4 is a block diagram of one particular implementation of a system according to an embodiment of the invention;

FIG. 5 is a block diagram of a user interface generated in accordance with an embodiment of the invention;

FIG. 6 is a flow diagram illustrating a method according to an embodiment of the invention;

FIG. 7 is a block diagram of a user interface generated in accordance with another embodiment of the invention; and

FIG. 8 is a block diagram of interfaces between various components of a system in accordance with an embodiment of the invention.

### DETAILED DESCRIPTION OF PREFERRED EMBODIMENTS

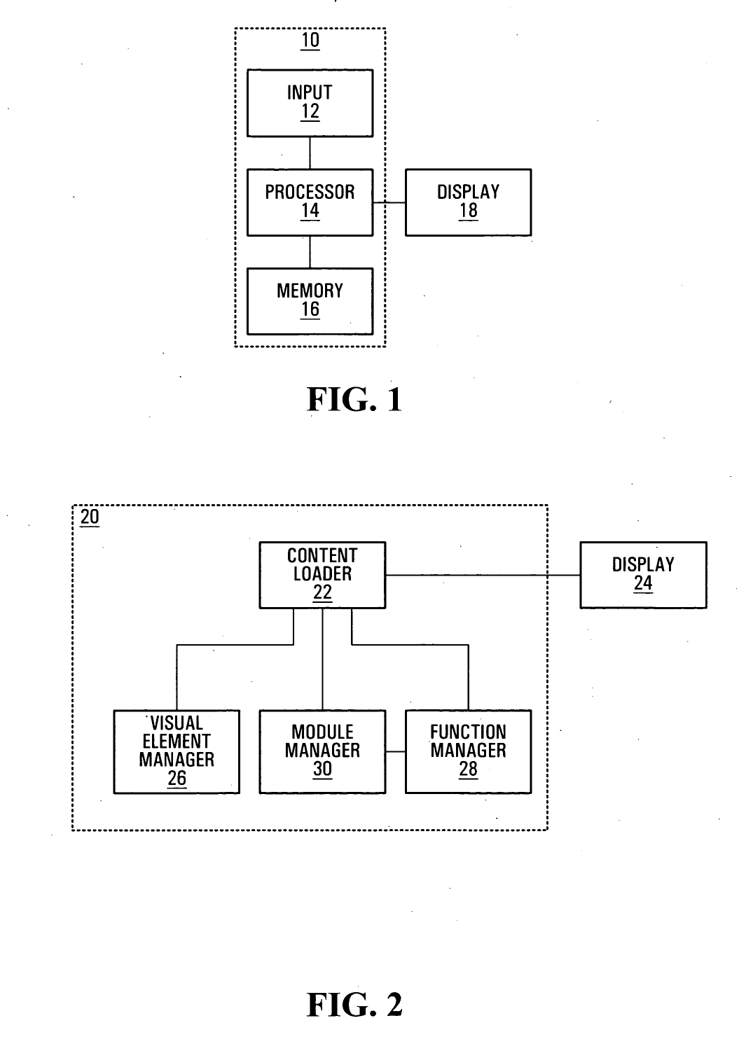

FIG. 1 is a block diagram of an example processing system in which the present invention may be implemented. The processing system 10 includes a processor 14 connected to an input 12, a memory 16, and a display 18. Those skilled in the art will appreciate that only components directly involved in an implementation of an embodiment of the invention have been shown in FIG. 1, and that a processing system may include further, fewer, or different components than those explicitly shown. FIG. 1 is intended solely for illustrative purposes; the invention is in no way limited to processing systems comprising the components and the interconnections therebetween as shown in FIG. 1.

The processor 14 is preferably a microprocessor that is configured to execute software, such as operating system software, software applications, and other types of software components. The electronic content processing operations described below are preferably embodied in software that is executed by the processor 14.

The input 12 is intended to represent any of a plurality of types of input devices or interfaces through which the processor 14 may receive inputs from a user or some other source. Common types of input devices include keyboards, communication ports or modules, modems, and network connections, for example, although other types of input devices will be apparent to those skilled in the art.

The memory 16 stores at least software to be executed by the processor 14, and may also store other information for access and processing by the processor 14. The memory 16 may include one or more types of memory, such as solid state memory components, disk drives, hard drives, or memory stick or card readers for instance. Although shown within the processing system 10, it is contemplated that the memory 16 may be implemented as or include one or more remotely accessible data stores.

In FIG. 1, the display 18 is shown as an example of a component that may be controlled by the processor 14 and software that it executes. According to a preferred embodiment of the invention, the processor 14 processes electronic content, which in one example instance is a user interface (UI) definition for a software application. Such a UI definition affects the “look and feel” of a presentation of information to a user via the display 18. The display 18 may, for example, be any type of television, a computer system monitor, an LCD (Liquid Crystal Display) on a mobile computing device such as a mobile telephone, or some other type of display. It should be appreciated that other types of content than UI definitions may be processed in accordance with the techniques described herein. Electronic content includes virtually any type of document or information that may be processed by an electronic device. As will become apparent from the following description, embodiments of the invention provide for processing of content in a portable format that can be loaded and processed by any processing system in which the invention is implemented. Content may thus be developed without low-level software development in programming languages such as C, for example.

The particular realization of the components shown in FIG. 1 is dependent upon the type of electronic device in conjunction with which the processing system 10 is implemented. In a preferred embodiment, the invention is implemented as embedded software in an electronic device that includes the input 12, the processor 14, and the memory 16. In a particularly preferred embodiment, the electronic device is a television signal receiver such as a cable television receiver or satellite receiver. In this case, the display 18 is preferably some type of television or video monitor.

In operation, the processor 14 accesses or receives content and other information, if any, involved in the processing the content from the input 12, through a software download from the Internet, for example, the memory 16, such as from a CD, or both. When implemented in a television signal receiver, content and information may be received in a video signal from a satellite or cable television system. Content processing according to embodiments of the invention is described in further detail below.

FIG. 2 is a block diagram of a system according to an embodiment of the invention, and includes a content loader 22 connected to a display 24, a visual element manager 26, a function manager 28, and a module manager 30. Those skilled in the art will appreciate that connections as shown in FIG. 2 are not necessarily physical connections, particularly in primarily software-based implementations. A “connection” in this context may be a transient condition, in the sense that the content loader 22 and the managers 26, 28, and 30 interact as required without maintaining a continuous connection.

As in FIG. 1, the display 24 is shown in the system 20 as one illustrative example of equipment that may be controlled by or used to display content that is processed according to techniques disclosed herein.

The content loader 22 is preferably a software component that receives and loads content, illustratively a UI definition for a software application, from an input or memory. The content may be received from either a local or remote source. The content loader 22 includes software code that supports a set of primitives or internal visual elements and functions that may be accessed by content being loaded. In a preferred embodiment, internal visual elements and functions are general-purpose software elements that provide base or core functionality of the system 20.

As described briefly above, content is preferably in a portable format that can be loaded and processed by any content loader 22. The content loader 22 also performs any necessary format conversion to convert content into an internal format or structure for further processing by the system 20. For example, in a preferred embodiment, the content loader 22 includes a parser to parse content for rendering by a content renderer, which may be part of the content loader 22 or a separate software component.

A visual element, as the name implies, has some sort of visual component that is presented on the display 24. Visual elements may be embedded in content and resolved during content loading. According to one embodiment, software code supporting a visual element also includes script functions or function calls, such that an embedded visual element may manipulate content, and is not merely placed at a defined location within displayed content as in known content processing systems.

Script functions may also manipulate content. According to embodiments of the invention described in further detail below, although content may include script functions or calls thereto, content may also be manipulated by script functions or other software components that are not explicitly referenced or called by the content. Thus, in one sense, visual elements may be considered as having “requested” access to content, whereas script functions and software modules described below may have “unrequested” access to content.

Internal visual elements and/or script functions supported by software code segments in or associated with the content loader 22 or other internal software modules provide for basic or core content processing functionality. These internal functions are preferably built into the system 20 by a device manufacturer or software provider, for example. In some implementations, this core functionality may meet all of a customer's requirements. However, in many implementations, additional or extended functionality may be desired or required. The managers 26, 28, 30 provide a framework within which such additional functionality may be integrated into a content processing system.

The managers 26, 28, 30, like the content loader 22, are preferably software components. These managers 26, 28, 30 support registries for different types of software components. In the system 20, the visual element manager 26 provides a registry for visual elements, the function manager 28 provides a registry for script functions, and the module manager 30 provides a registry for software modules, which may support visual elements, script functions, other types of processing, or some combination thereof.

Through the managers 26, 28, 30, visual elements and script functions are exposed to electronic content, and software modules are exposed to other software modules and components of a content processing system. Internal visual elements and script functions are available to the content loader 22. The content loader 22 itself may be made available to other components through registration with the module manager 30.

The content loader 22 and the managers 26, 28, 30 implement well-defined and documented interfaces according to which content, visual elements, script functions, and software modules may be developed for the system 20. Such interfaces simplify the development of content, visual elements, script functions, and software modules in that these components become portable between different systems 20 in which the content loader 22 and the managers 26, 28, 30 are implemented. Portability is further enhanced by also providing well-defined interfaces between the components of the system 20 and lower level components of a native system in which the system 20 is implemented, as described in further detail below.

It should be appreciated that “well-defined” and “documented” are not intended to imply that the interfaces presented by the content loader 22 and the managers 26, 28, 30 are standardized or known interfaces. Virtually any interface definitions may be used to implement embodiments of the invention, provided the interfaces are defined. Distribution of interface definitions or documentation to software developers is generally preferred to provide the broadest software development base, although many benefits of the invention may be realized with proprietary interfaces. As will become apparent from the description below, although the interfaces are preferably defined, the invention is in no way restricted to any particular interface definition.

Visual elements may be registered with the visual element manager 26 by software code segments or software modules that support the visual elements. In FIG. 2, for example, any visual elements registered with the visual element manager 26 are accessible to electronic content through the visual element manager 26. The registration function is preferably enabled through defined APIs (Application Programming Interfaces) of the visual element manager 26.

During registration, a visual element name and a callback are preferably registered with the visual element manager 26. The visual element is then accessible through the visual element manager 26 using the registered name. The name assigned to the visual element is preferably set in a corresponding visual element code segment that supports the visual element by a software developer in accordance with a naming scheme that has been defined as part of the interface definitions described above. For example, in an implementation of the invention in a television receiver, an EPG (electronic program guide) grid visual element registered with the visual element manager 26 using the name “epg_grid” may be embedded in content as
<OBJECT type=“epg_grid”>
</OBJECT>.

The function manager 28 similarly provides a registry, but for script functions instead of visual elements. A software module or other component preferably uses APIs or some other type of interface provided by the function manager 28 to register any script functions that are to be exposed up to other components of the system 20 with the function manager 28. At least a script function name defined in the interface definitions and a callback, which is a pointer to the script function in the code space of the component that registered the script function, are preferably registered with the function manager 28. Through the function manager 28, registered script functions are exposed to and thus accessible by electronic content.

The module manager 30 provides for registration of the software modules to thereby support interaction between different software modules. Module registration is preferably substantially as described above for visual elements and script functions. Each software module that is to be accessible to other software modules or system components registers a module name, specified as part of an interface definition, and a callback through which other components may communicate with the registered software module. As above, name and callback represent an illustrative example of registration information that may be provided during registration.

In a preferred embodiment, the module manager 30 also exposes APIs to support at least a query function through which a component may determine whether other software modules are registered. In response to such a query, the module manager 30 may provide an indication of whether a particular software module is registered, and if so, the callback for the software module. In another embodiment, the module manager 30 supports separate query and callback request functions. A software module then requests the callback for another module after an indication that the other module exists is received in response to a query.

The module manager 30 thus facilitates discovery or detection of software modules by other software modules or components, but is preferably not involved in inter-module communications and operations. After a software module has obtained from the module manager 30 the callback or some other information that allows it to establish communications with another software module, for example, the software modules preferably communicate with each other directly, such as through callbacks and a callback handler, instead of through the module manager 30.

The query function of the module manager 30 is also preferably registered with the function manager 28, to thereby expose the query function to the content loader 22, and hence any content being loaded, as well as other system components.

The managers 26, 28, 30 thereby provide separate registries for different types of software components, namely visual elements, script functions, and software modules. In the system 20, the module manager 30 may register its query function, for example, with the function manager 28. In a similar manner, the content loader 22 may register itself with the module manager 30.

It should be appreciated, however, that although the managers 26, 28, 30 are preferably provided in a basic implementation of a content processing system according to an embodiment of the invention, the registries maintained by these managers need not necessarily be populated. As internal visual elements and script functions are directly accessible to the content loader 22, core content processing functionality need not involve any interaction with the managers 26, 28, 30. Registration with the managers 26, 28, 30 exposes visual elements, script functions, and software modules to electronic content and other system components. In the system 20, the content loader 22 is the only software module.

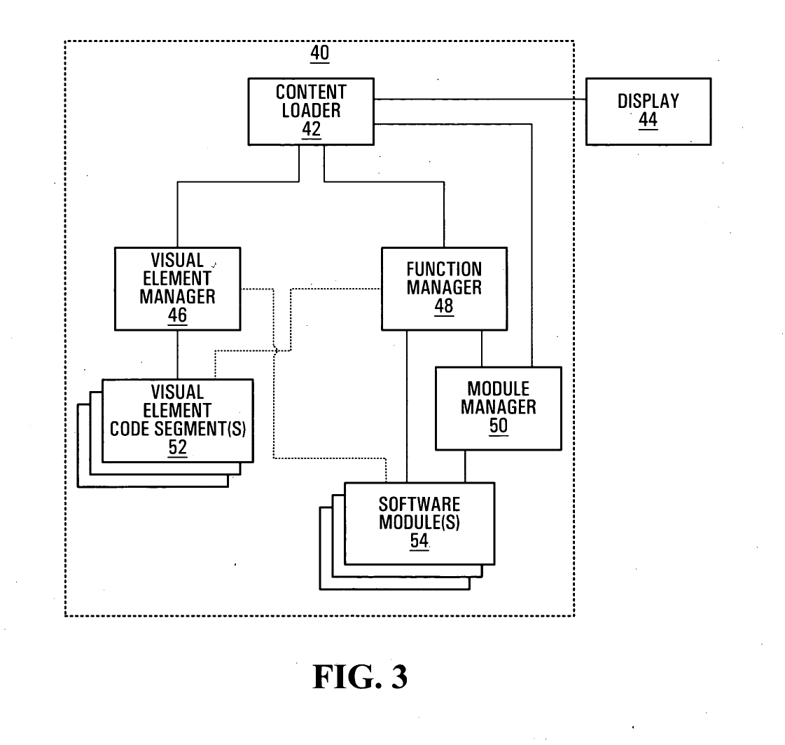

FIG. 3 is a block diagram of a system according to a further embodiment of the invention. The system 40 includes a content loader 42, a display 44, a visual element manager 46, a function manager 48, a module manager 50, one or more external visual element code segments 52, and one or more external software modules 54. As described above with reference to FIG. 2, the connections in the system 40 are not necessarily permanent physical connections.

The system 40 is substantially similar to the system 20, with the exception of the external visual element code segments 52 and the external software modules 54. The content loader 42, the display 44, and the managers 46, 48, 50 are substantially the same as similarly labelled components in FIG. 2, although in the system 40, core content processing functionality has been extended by providing external visual elements, script functions, and software modules.

Each visual element code segment 52 includes a portion of software code that may be called by the visual element manager 46 in response to access requests from the content loader 42. Any software module 54 that registers script functions with the function manager 48 similarly includes software code that is called in response to access requests from the content loader 42. It should be appreciated that the external software modules 54 may also include software code for other types of processing operations than script functions. According to an embodiment of the invention, an external software module 54 is enabled for access to content without specifically being called by or referenced in the content.

The visual element manager 46 provides a registry through which external visual elements can be accessed by content loaded by the content loader 42. Each external visual element code segment 52 registers a corresponding external visual element with the visual element manager 46, which exposes the external visual element to the content loader 42 and thus any content being loaded thereby. The function manager 48 similarly exposes any registered external script functions, provided by the external software modules 54, for example, to the content loader 42.

In the system 40, the external visual element code segments 52 may also support external script functions. These script functions are registrable with the function manager 48, as indicated by the dashed line between the external visual elements 52 and the function manager 48. This represents a further advantage of defined interfaces, in that external visual element code segments 52 associated with visual elements may support and register external functions that are then accessible by content.

One or more of the external software modules 54 may register with the visual element manager 46 any visual elements for which they incorporate software code segments. In this case, visual element registration is substantially as described above, although the software code segments for such visual elements reside in the software modules 54. For name/callback visual element registration for instance, the callback for a visual element registered by a software module 54 is a pointer in the codespace of that software module.

Thus, external visual elements and script functions may originate with and be supported by visual element code segments 52, software modules 54, or both.

It should be noted that although the visual element manager 46 and the function manager 48 interact with software code that supports both visual elements and script functions, access operations may remain separate. External visual element access is through the visual element manager 46, and external script function access is through the function manager 48. The managers 46, 48 provide a mechanism for content to access embeddable external visual elements and external script functions.

For example, an external script function may be registered with the function manager 48 by a visual element code segment 52 in order to allow content that is embedding an external visual element supported by that code segment to also manipulate occurrences or instances of the visual element. Consider an interactive slider as an illustrative example of a visual element named “S1” embedded within content as
</OBJECT ID=“S1” TYPE=“slider” WIDTH=“200” HEIGHT=“30”>
<PARAM NAME=“MIN” VALUE=“0”>
<PARAM NAME=“MAX” VALUE=“100”>
<PARAM NAME=“VALUE” VALUE=“30”>
</OBJECT>.

This visual element would be initially rendered as a slider of width 100 indicating a present value of 30. In order to allow content to change the “VALUE” parameter and thus the appearance of the slider, in response to received data or user input, for example, the visual element code segment 52 that registered the slider with the visual element manager 46 might also register a script function, such as “slider.set_value( )”, with the function manager 48. Where content then wishes to change the slider to indicate a present value of 75, the registered function is accessible as “slider.set_value (”S1“, 75). Of course, the above is one example of a visual element and associated script function, and the invention is in no way limited thereto.

The module manager 50 may similarly maintain a registry of both internal and external software modules. The content loader 42 is an example of a registrable internal software module. External software modules are shown at 54. Any of the external visual element code segments 52 may also register with the module manager 50 in order to provide for more direct interaction with other components of the system 40 through registered names and callbacks for instance.

Registration of visual elements, script functions, and software modules may be responsive to any of a number of triggers. As described above, internal software modules need not necessarily register with the module manager 50 unless interaction with other components is desired or required. For any internal components or external visual element code segments 52 and software modules 54 that exist when the system 40 is started, registration may be initiated at startup, for example. New external visual element code segments and software modules may register visual elements and script functions with the managers 46, 48 and themselves with the module manager 50 when they are installed in the system 40 or the next time the system 40 is started. These types of triggers may be regarded as initialization triggers. Visual element, script function, and software module registration may also be dependent upon the registration of other visual elements, script functions, or software modules, installation or presence of particular equipment, a user input, or some other runtime event or trigger. Software module registration, like visual element and script function registration, may be invoked at startup, when a software module is installed, or when other components are installed, for example. It should also be appreciated that registration of a software module 54 with the module manager 50 is optional. In a preferred embodiment, registration timing and conditions are established in software code that supports a registrable component. For example, the content loader 42, each external visual element code segment 52, and each software module 54 preferably includes software code that establishes when and with which of the managers 46, 48, 50 registration is to be performed.

De-registration of visual elements, script functions, and software modules is also contemplated, such as when a visual element or function is no longer to be supported or a software module is to be removed.

It will thus be apparent that the systems 20 and 40 provide a dynamic processing system. Access to external visual elements, external script functions, and software modules by other system components is controlled through registration with the managers 46, 48, 50. The defined interfaces also simplify upgrades and other modifications in that content need not be updated to reflect new versions of visual elements, script functions, or software modules. Upgraded versions of internal or registered external visual elements, script functions, and software modules are accessible to content using the same names, even though software code may have been upgraded.

Another advantageous feature of the systems 20 and 40 is that the system 20, which supports internal visual elements and script functions, is substantially similar to the system 40. The core components, particularly the managers 26, 28, 30 and 46, 48, 50, are common to both systems. An electronic device manufacturer or software provider may thereby develop a core content processing system that is configured to process content in a portable format, in a markup language for instance. Another entity, such as a customer or even a user, is then able to customize or extend the core system to utilize external visual elements, script functions, and software modules.

Embodiments of the invention are thereby dynamic in at least two senses, for content and for functionality. Any content in the preferably portable format can supply a different look and feel for the same underlying functionality supported in a content processing system. By changing content, such as for different platforms or “on the fly“for a single processing system, a dynamic look and feel is provided for the same functionality. The functionality of a content processing system is also dynamic. The managers provide for extending core functionality with external components. Such flexibility is provided without redesign or substantial software programming development.

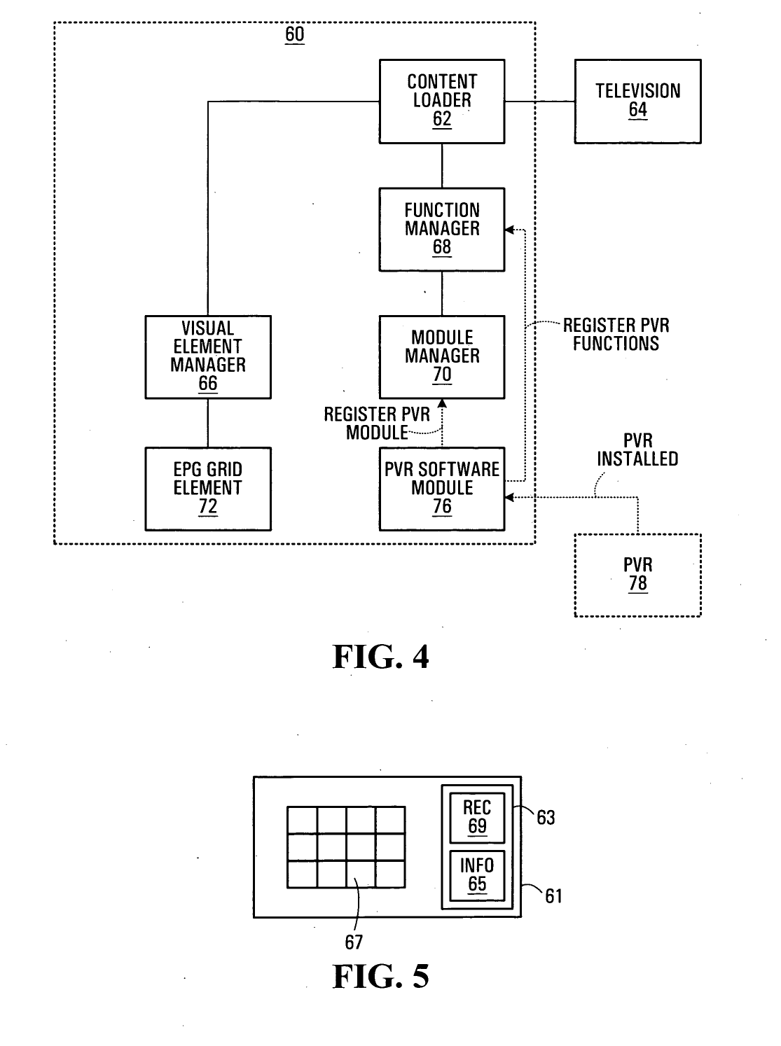

FIG. 4 is a block diagram of one particular implementation of a system according to an embodiment of the invention, from which registration processes and content processing will become apparent. The system 60 is substantially similar to the system 40, and includes a content loader 62, connected to an external television 64, a visual element manager 66, a function manager 68, and a module manager 70. An EPG grid element 72 has been registered with the visual element manager 66. Although a PVR software module 76 is present in the system 60, it is assumed for illustrative purposes that this module has not registered with the module manager 70 or the function manager 68, as its functions are associated with a PVR 78. The system 60 would be applicable, for example, to a cable television receiver or satellite receiver.

Operation of the system 60 will now be described in the context of an illustrative example wherein the content provides a UI definition for a programming guide software application. The content has embedded references to the external visual element 72 and a “record” icon as an internal visual element supported by the content loader 22, and also includes a function call associated with the record icon 74.

When the programming guide software application is executed, the content is loaded and rendered for display on the television 64. In a preferred embodiment, a UI is built from the content and displayed when a user depresses a “guide” or like key on a receiver or remote control. However, the UI is not necessarily immediately displayed on the television 64.

The EPG grid element 72 is effectively a template into which programming information received by the processing system 60 is inserted. When an embedded reference to this element, “epg_grid” for example, is encountered by the content loader 62, it is requested from the visual element manager 66, which uses the registered name and callback to retrieve the EPG grid element 72 and return the element to the content loader 62. Although the actual content of a visual element is fixed in the software code segment supporting the visual element, the content loader 62, or strictly the content, may control properties of visual elements, such as size and position for instance.

According to one embodiment of the invention, access to the grid element 72 and other registered visual elements may be provided through a defined type object which is representative of meta information of a visual element. A type object is returned to the content loader 62 when the visual element manager 66 successfully matches a requested visual element to a registered name. The type object is then used as a handle to obtain a further type object which is a subclass of a primitive element of the processing system and inserted into the display representation of the content being loaded. The returned type object thus leads to the visual display of the visual element. Even though display of the visual element relates to a primitive element of the processing system in this embodiment, the visual element is accessible to the content through a defined name. The content does not need to be aware of or compatible with primitive elements of the processing system to access visual elements. Other access mechanisms may also be apparent to those skilled in the art.

Display of an embedded record icon, which is an internal visual element in this example, is preferably dependent upon the availability of a recording function. Several control mechanisms governing the display of such a visual element are possible. For example, a determination of whether the PVR software module 76 has been registered may be made, such as through the query function described above, before the record icon visual element is displayed. This determination may be made before the embedded record icon visual element resolved or retrieved, or after the visual element has been retrieved but before it is displayed. The content loader 62 determines whether the query function is registered and then queries the module manager 70, through the function-manager 68, using the defined name of the PVR software module 76 for example. The record icon is preferably not displayed if, as in this example, the PVR software module 76 has not been registered with the module manager 70.

In another embodiment, the retrieval and display of the record icon is dependent upon a function query to the function manager 68. As described above, a software module need not necessarily register with both the module manager 70 and the function manager 68. In this case, the content loader 62 queries the function manager 68 to determine whether a PVR record function is available, and if so, displays the internal record icon visual element. However, where the PVR software module 76 exists but has not registered itself with the module manager 70 or a record function with the function manager 68, the record icon is preferably not retrieved or at least not displayed.

The above determinations of registered modules or functions may, for example, be performed when content loading is started, or at a later time prior to displaying the record icon in the UI. Determinations may also be integrated into a visual element software code segment such that a visual element is retrieved and any necessary determinations are then performed before the visual element is displayed. Thus, a UI may include visual elements whose visibility is determined by such determinations.

In other embodiments, determinations as to whether functions or visual elements have been registered may be implicit in an access request instead of a separate operation. A software code segment for a requested visual element or function, for example, is returned or executed when the software element is available, without an explicit, separate determination of availability.

As indicated by the dashed arrows in FIG. 4, registration of the PVR software module 76 with at least the function manager 68 and possibly the module manager 70 is initiated when the processing system 60 is provided in an electronic device in which or in conjunction with which the PVR 78 has been installed, such as by connection to a television receiver in which the system 60 is implemented.

In one embodiment, the PVR 78 is configured to communicate with the PVR software module 76 to enable functions of the PVR 78 to be accessible through the system 60. The same interface used for communications between the PVR software module 76 and the PVR 78 may be used by the PVR software module 76 to determine that the PVR 78 has been installed or by the PVR 78 to notify the PVR software module 78 that a PVR has been installed.

The module manager 70 may also support other types of triggered registration. As will be apparent to those skilled in the art, the system 60 may include device interfaces that may be used by different types of devices. A Universal Serial Bus (USB) interface is an example of such an interface, through which printers, pointing devices, cameras, and many other types of devices may be connected to an electronic device. In the system 60, a USB software module may be provided to allow other components of the system to access connected USB devices. The USB software module preferably registers with the module manager 70, detects connection of the USB device to a USB interface, and then notifies any other registered software modules that may interact with the connected device that the device has been connected. Registration of the USB software module itself could also be triggered by connection of a device.

It should also be appreciated that runtime triggers may invoke de-registration of software modules, functions, and visual elements. As functions of the PVR software module 76 are dependent upon the presence of the PVR 78, disconnection or failure of the PVR 78 is preferably detected by the PVR software module 76, which then performs de-registration operations so as to avoid function calls for functions that are no longer supported.

A dynamic processing system is thereby provided. Each time content is loaded, or possibly during content loading, different sets of visual elements and script functions may be available, and can be detected. The same content may also behave in different ways depending upon the available visual elements and script functions. In the above example of a UI definition for a programming guide software application, the same content provides a UI that includes a record icon for a first processing system that includes or is connected to a PVR, and a UI that does not include the record icon for a second processing system in which no PVR or recording function is available.

FIG. 5 is a block diagram of such a UI generated in accordance with an embodiment of the invention. In FIG. 5, a screen 61 displayed to a user on a monitor such as the television 64, would include the EPG grid element 67, which is preferably populated using received program schedule information. Another area 63 of the screen 61 displays function buttons, a record icon 69 and an information icon 65. Responsive to user inputs from a remote control or other input device, a cursor or pointer may be navigated to a particular program in the EPG grid 67. The program may then be recorded or information relating to the program may be displayed on the screen 61 or a separate screen or window in response to further user input, such as operation of a record or information key or selection of the record icon or information icon.

With reference to the preceding example, the record icon 69 is preferably made visible only when a record function is available. For an implementation in which no record function is available, the record icon is invisible, shadowed, or otherwise indicated as being inoperable. The capability to display program information is moreso core functionality for a program schedule, and as such is preferably available as an internal visual element, script function, or more likely a combination thereof.

From FIG. 5, it will be apparent that a record icon and PVR software module may be provided for a content processing system that may be used with or without recording equipment. Visual elements and script functions may be used differently in different implementations by the same content. In addition, an upgrade, such as installing a recording device, would be automatically detected by the content.

The managers and defined interfaces provide an architecture in which resources may be shared between content. Through the managers, external visual elements and script functions are exposed to content and software modules may interact with each other. The defined interfaces specify a framework within which external visual element code segments and script functions, software modules, and content are fully portable between processing systems. Even though different processing systems may include the same managers, the external visual elements, script functions, and software modules with which the managers interact can be customized, by a manufacturer of a content processing system, a vendor, a manufacturer of an electronic device in which a content processing system is to be implemented, or even a user, for example. Distribution of interface definitions allows development of content, visual element code segments, and software modules by parties other than an original manufacturer of a content processing system or device. Such distribution also tends to significantly increase the size of a development community and thus the range of compatible content, visual elements, and functions that become available.

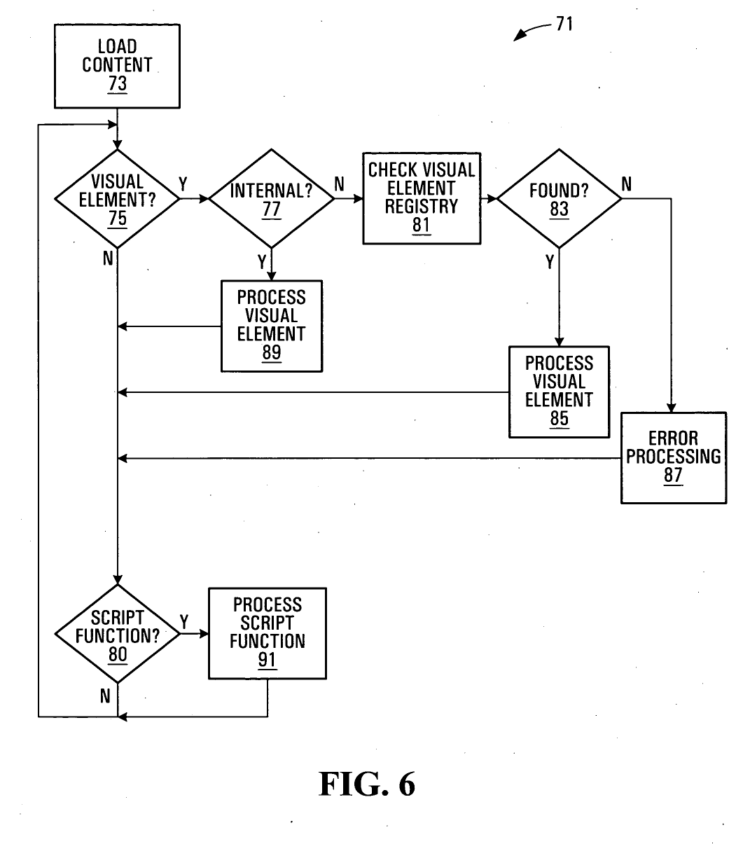

FIG. 6 is a flow diagram illustrating a method 71 according to an embodiment of the invention. As above, a UI definition is considered as an illustrative example of content. It should be appreciated that the invention is in no way limited to such content, however.

At 73, content is loaded. If an embedded visual element is encountered, as determined at 75, then a determination is made at 77 as to whether the visual element is an internal or external visual element. For an external visual element, a visual element registry, which is maintained by a visual element manager in the systems described above, is checked at 81, and if the visual element is found (83), then it is processed at 85. Visual element processing may involve such operations as retrieving one or more type objects and inserting a type object into a representation of the content, for example. If the external visual element is not found at 83, then error processing is performed at 87. Error processing at 87 may involve determining that content processing may continue without an unavailable visual element, as shown, or aborting content processing, for example.

Internal visual elements are directly accessible to content, and as such, internal visual elements are processed at 89 for insertion into a representation of the content and eventual display.

When a script function is encountered at 80, the function is processed at 91, if necessary, by a script compiler, for example. In the present example of a UI definition as content, script function execution is normally in response to user inputs or other events that occur when content has been loaded and the UI has been displayed.

In one illustrative embodiment, a UI definition includes logical layout and control information. A markup language, such as HTML (Hypertext Markup Language), provides these capabilities in markup for the logical layout including visual elements and scripts, in Javascript for instance, for control. Other suitable development languages for content will also be apparent to those skilled in the art.

Content may also include information or data, such as labels or other text to be built into a UI. In a programming guide, this information may include such information as times, dates, and program names. As will be apparent, information may also or instead be received and then displayed within the UI. Although only visual element and script function processing has been shown in FIG. 6, it should be appreciated that other types of information in loaded content is also processed as necessary during or after loading. Thus, the invention is in no way restricted to methods including the particular operations in the order shown in FIG. 6. Further variations of the method 71 will be apparent to those skilled in the art.

According to another aspect of the invention, software modules, whether called through registered functions, invoked by a user, or self-initiated in response to a runtime trigger such as loading of content, for example, may also modify content. Thus, although some of the foregoing operations may appear to be somewhat similar to rendering operations performed by a browser, content processing techniques according to aspects of the invention provide several advantages over known browser technologies.

For example, instead of a notion of just an embedded plug-in, as in a browser, software elements are separated into distinctly registrable parts according to embodiments of the invention. An embedded visual element is resolved during loading of content using a well defined naming scheme. As described above, content may embed external visual elements which are resolved using a visual element registry. Software modules and functions need not be embedded into content to manipulate the content.

Software modules, which may include visual element code segments, can similarly be registered with a module manager and located by other modules using a well defined naming scheme, and are thus accessible to other modules if callbacks have been exported or exposed via the module manager. These modules may also be located by content using the same naming scheme and registered script functions, such as the query function described above, registered by the module manager with a function manager. If a software module has registered its functions with the function manager, then these functions are also accessible to content.

Although a module manager facilitates software module discovery and subsequent interaction between software modules, software modules may instead be more statically linked, so as to communicate more directly. For example, a USB software module may be statically linked to any other software modules associated with USB devices that may be connected to a content processing system.

Separation between these types of software components provides several benefits. For example, a browser plug-in must be embedded in any content to be loaded. A software module or script function, however, need not be associated with any particular content. In one embodiment, a content loader, itself a software module, provides an interface by which other software modules may assign a callback for notification whenever content is loaded. Through the module manager, other software modules can find the content loader and then register for such notifications. In a preferred embodiment, module-specific filter settings may also be established during registration for notification to set particular types of content for which notifications are generated. Each software module simply ignores notifications for certain types of content in other embodiments. Along with a notification, the content loader supplies a handle to a representation of the content in memory, which may be considered a content document. The software module may then proceed to access and manipulate the content, using the handle. Content may thereby be accessed and manipulated by an external software component, a software module in this example, to which no reference is made in the content. The content itself may not even be aware of such a software module. This level of integration is not provided in browsers or other known content processing systems.

In addition, visual elements are completely integrated into content. This allows a visual element to access and directly manipulate other content around it, not just remain at one position within content, substantially “unaware” of its surroundings. As described above, a visual element in one embodiment is a subclass of a primitive element of a processing system and thus is no different than any other primitive element. However, in order to enable display of a visual element, a content handle is preferably passed to a visual element code segment. The content handle allows a visual element, like a software module, to examine and manipulate content.

A further advantage of this kind of functional segregation is that systems according to embodiments of the invention are not encumbered by the semantic limitations of any particular mark-up language. Visual elements, software modules, and script functions can directly access and manipulate any aspect of content, which allows for more complete and complex control of content than permitted by known browsers or other content processing systems.

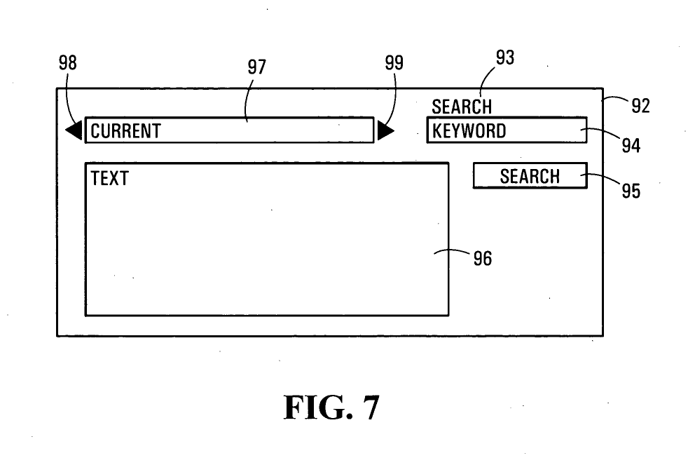

FIG. 7 is a block diagram of a UI generated in accordance with another embodiment of the invention. The UI generates a screen 92 on a display, including an information display window 96, a title or index window 97 indicating a current information selection for display, directional arrows 98, 99, a search title 94, window 94, and button 95. The directional arrows 98, 99, the search title 93, the search window 94, and the search button 95 are illustrative of example visual elements, which may be internal or external, resolved during processing of content, and displayed to a user. User inputs to operate the directional arrows 98, 99 invokes a related function to change the information displayed at 96. Similarly, entry of a search keyword in the window 94 and operation of the search key 95, both visual elements in this example, executes a search function, such as to highlight occurrences of the keyword in the text in the window 96 or to otherwise manipulate the content.

It should be noted that the provider of the content need not be aware of this search function. If the content is compatible with the content processing system, then the search function, as well as other functions, is operable in conjunction with the content.

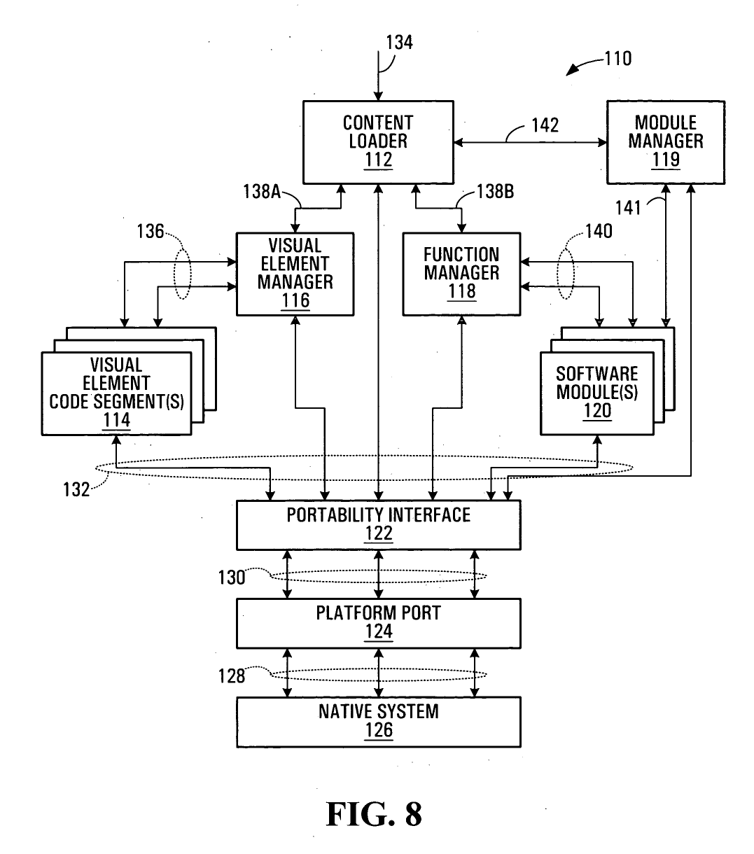

FIG. 8 is a block diagram of interfaces between various components of a system in accordance with an embodiment of the invention. The system 110 is built to operate on a native system 126, which includes the physical components such as a processor, memory, inputs, and other processing system components. The native system 126 thus includes hardware in conjunction with which software is executed to provide the interface structure shown in FIG. 8.

The platform port 126 and the portability interface 122 provide for translation between native system protocols indicated at 128 and content processing system protocols indicated at 132. Such translation may alternatively be accomplished using more than two ports or interfaces, or a single port. However, two layers are shown in FIG. 8 to illustrate one possible implementation of a portable software architecture. The platform port 124 is dependent upon the native system 126, and may, for example, be designed by a provider of a content processing system or another entity, such as an owner of the native system 128. The portability interface 122 effectively reduces the extent of translation that the platform port is required to perform. The platform port translates between the protocol 128 to the protocol 130, which is preferably another defined protocol or interface. Any remaining translation between the protocol 130 and the processing system protocol 132 is performed by the portability interface 122. Any platform port 124 configured to operate with the protocol 130 is therefore enabled for operation with any processing system that presents this protocol. As such, the platform port 124 is the only custom component in the system 110. All other components are portable between native systems 126 that include a platform port 124.

As described above, the portability interface 122 also presents a defined interface 132 to any components in a content processing system that may access or be accessed by components of the native system 126. For example, the platform port 124 and the portability interface 122 provide for passing of user input or other native system events to the content loader 112, such as through an event queue (not shown), for processing. A key press on a television receiver remote control could be posted by the native system 126 to an event queue for subsequent retrieval and processing by an event handler to change a program guide for instance.

Interfaces between the visual element code segments 114 and the visual element manager 116, between the software modules 120 and the function manager 118, between the software modules 120 and the module manager 119, between the managers 116 and 118 and the content loader 112, and between the module manager 119 and the content loader 112, respectively designated as 136, 140, 141, 138A/138B, and 142 in FIG. 8 are also defined. A defined common interface or protocol 134 can thus be presented to content by the content loader 112. Content need only be designed to implement the interface or protocol 134 in order to access software elements and modules in any content processing system 110. Other advantages of such defined interfaces have been described above.

The architecture of FIG. 8 provides for portability of a content processing system and integration of software for such a content processing system in different types of electronic devices. The same content may be executed on different types of devices. Similarly, a user is presented with a substantially seamless experience between different content, as the same software elements and modules are available to all content that is loaded by a processing system.

What has been described is merely illustrative of the application of the principles of the invention. Other arrangements and methods can be implemented by those skilled in the art without departing from the spirit and scope of the present invention.

For example, although illustrative examples of content, software elements, and software modules have been described above, other types of content, elements, and modules will be apparent to those skilled in the art. The invention is in no way limited to the examples described above, or to any particular set of content, elements, or modules.

In addition, many different execution schemes for software applications and functions will also be apparent to those skilled in the art. In one embodiment, script function calls are passed by a function manager to a virtual machine, illustratively a JVM (Java™ Virtual Machine) for execution.

In addition, references to objects and instances above are intended solely for illustrative purposes. The invention is in no way limited to implementation in object-oriented programming environments.

1. A method of processing electronic content comprising:
providing an internal software module defining at least one internal software element;
providing a plurality of respective registries for different types of software elements, the plurality of respective registries comprising a software element registry for external software elements; and
processing electronic content using the internal software module to resolve embedded references in the electronic content to the internal software elements and embedded references in the electronic content to any external software elements in the software element registry,
wherein the external software elements in the software element registry comprise at least one external software element supported by software code, wherein processing to resolve embedded references in the electronic content to the at least one external software element comprises supplying a handle associated with the electronic content, and wherein the electronic content is accessible to the software code using the handle.

2. The method of claim 1, further comprising:
providing a plurality of external software elements; and
registering each of the plurality of external software elements in the software element registry.

3. The method of claim 1, wherein the at least one internal software element comprises an internal visual element having a visual component for display, and wherein the at least one external software element comprises an external visual element having a visual component for display.

4. The method of claim 2, wherein each external software element is supported by software code, and wherein registering comprises providing registration information for each external software element from its supporting software code to the software element registry.

5. The method of claim 4, wherein the registration information comprises an external software element name and a pointer to a portion of the software code supporting the external software element.

6. The method of claim 1, wherein processing to resolve embedded references in the electronic content to any external software elements in the software element registry further comprises:
requesting each embedded external software element from the software element registry;
determining whether the embedded external software element has been registered in the software element registry; and
returning a representation of the external software element where the embedded external software element is registered in the software element registry.

7. The method of claim 1, wherein the software code manipulates the electronic content using the handle.

8. The method of claim 1, wherein the plurality of registries further comprises a software module registry for software modules.

9. The method of claim 8, further comprising:
providing at least one external software module; and
registering with the software module registry each external software module that is to be accessible to the internal software module any other external software modules.

10. The method of claim 9, further comprising:
registering the internal software module with the software module registry.

11. The method of claim 9, wherein the at least one external software module comprises an external software module supporting an external software element, further comprising:
registering the external software element with the software element registry.

12. The method of claim 11, wherein the internal software module supports a notify function to notify the at least one external software module that electronic content is being processed, further comprising:
registering for the notify function each external software module that is to be notified that electronic content is being processed;
providing a notification to each external software module registered for the notify function that electronic content is being processed.

13. The method of claim 12, wherein providing a notification comprises supplying a content handle using which the electronic content is accessible.

14. The method of claim 13, wherein at least one of the external software modules registered for the notify function accesses and manipulates the electronic content using the content handle.

15. The method of claim 9, wherein the plurality of registries further comprises a script function registry for script functions.

16. The method of claim 15, wherein the at least one software module comprises a software module that defines at least one script function, further comprising:
registering with the script function registry each of the at least one script function that is to be accessible to the electronic content.

17. The method of claim 1, wherein the electronic content comprises a UI (user interface) definition for a software application.

18. The method of claim 17, wherein the software application is a television program schedule application.

19. The method of claim 1, implemented in a television receiver.

20. A computer readable medium storing statements or instructions which when executed by a processor perform the method of claim 1.

21. The method of claim 15, further comprising:
calling a script function referenced in electronic content using a content handle,
wherein the electronic content is accessible using the handle.

22. The method of claim 16, wherein the software module registry supports a query function for querying availability of software modules, and wherein registering with the script function registry comprises registering the query function with the script function registry.

23. A method of processing electronic content comprising:
providing an internal software module defining embeddable software elements;
providing an external software module;
processing the electronic content using the internal software module to resolve embedded references in the electronic content to the embeddable software elements;
notifying the external software module of the processing of the electronic content; and
accessing the electronic content by the external software module responsive to the notifying.

24. The method of claim 23, further comprising:
manipulating the electronic content by the external software module.

25. The method of claim 23, further comprising:
providing a software module registry;
registering an interface of the internal software module with the software module registry; and
registering the external software module with the internal software module using the interface to receive a notification of the processing of the electronic content.

26. The method of claim 25, wherein providing an external software module comprises providing a plurality of external software modules, wherein registering comprises registering with the internal software module using the interface each of the plurality of external software modules that is to receive a notification, and wherein notifying comprises notifying each external software module registered with the internal software module.

27. The method of claim 26, further comprising:
registering with the software module registry each of the plurality of external software modules that is to be accessible to the internal software module and other external software modules.

28. The method of claim 26, wherein the plurality of external software modules comprises software modules supporting embeddable external software elements, further comprising:
providing a software element registry for the embeddable external software elements; and
registering with the software element registry each of the embeddable external software elements that is to be accessible to the electronic content,
wherein processing further comprises resolving embedded references to the embeddable external software elements registered in the software element registry.

29. The method of claim 26, wherein the plurality of external software modules comprises software modules supporting external script functions, further comprising:
providing a script function registry for script functions; and
registering with the script function registry each of the external script functions to be accessible to the electronic content.

30. The method of claim 26, wherein the plurality of external software modules comprises software modules supporting at least one of embeddable external visual elements having a visual component for display on a display device and external script functions, further comprising:
providing a visual element registry and a script function registry for visual elements and script functions, respectively; and
registering with the visual element registry and the script function registry, respectively, each of the external visual elements and external script functions to be accessible to the electronic content.

31. A computer readable medium storing statements or instructions which when executed by a processor perform the method of claim 23.

32. A system comprising:
a plurality of software element managers, each software element manager maintaining a respective registry of software elements of a predetermined type, the plurality of software element managers comprising an embeddable software element manager maintaining a registry of embeddable externally defined software elements; and
an electronic content loader defining embeddable internal software elements, configured to receive electronic content, to resolve references in the electronic content to the embeddable internal software elements, and to resolve references in the electronic content to any embeddable external software elements in the registry of the embeddable software element manager,
wherein the embeddable external software elements in the registry of the embeddable software element manager comprise at least one embeddable external software element supported by software code, wherein the electronic content loader is further configured to resolve the references in the electronic content to the at least one embeddable external software element by supplying a handle associated with the electronic content, and wherein the electronic content is accessible to the software code using the handle.

33. The system of claim 32, further comprising:
a plurality of external software modules comprising an external software module defining at least one of the embeddable externally defined software elements,
wherein the plurality of software element managers further comprises a software module manager maintaining a registry of any of the external software modules that are to be accessible to the content loader and other external software modules.

34. The system of claim 32, wherein the plurality of software element managers further comprises a script function manager maintaining a registry of script functions, supported by at least one of the content loader and any of the external software modules, that are to be accessible to the electronic content.

35. The system of claim 32, wherein the plurality of software element managers provides a defined common interface for the electronic content, and wherein the processor is further configured to provide a custom interface between a native computer system and the plurality of software element managers.

36. A system comprising:
an internal software module defining embeddable software elements and configured to process electronic content by resolving references in the electronic content to the embeddable software elements; and
an external software module configured to detect the processing of the electronic content and to access the electronic content responsive to the detection.

37. The system of claim 36, wherein the internal software module is further configured to supply to the external software module a notification that the electronic content is being processed and a handle associated with the electronic content, and wherein the external software module is configured to detect the processing by receiving the notification and to access the electronic content using the handle.

38. The system of claim 36, further comprising:
a plurality of external software modules including the external software module; and
a software module manager maintaining a registry of software modules,
wherein the internal software module and at least one of the external software modules is further configured to register with the software module manager.

39. The system of claim 38, wherein the internal software module and the at least one of the external software modules is further configured to register with the software module manager upon detection of a respective registration trigger.

40. The system of claim 39, wherein the registration trigger is a trigger selected from the group consisting of: an initialization trigger and a runtime trigger.

41. An electronic device comprising:
a processor; and
a computer-readable medium accessible by the processor and storing instructions which when executed by the processor perform the method comprising:
providing an internal software module defining an embeddable internal software element;
providing a plurality of respective registries for different types of software elements, the plurality of respective registries comprising an embeddable software element registry for an externally defined embeddable external software element;
processing electronic content using the internal software module to resolve any embedded references in the electronic content to the embeddable internal software element and any embedded references in the electronic content to the embeddable external software element in the embeddable software element registry, wherein the embeddable external software element is supported by software code, wherein processing electronic content to resolve any embedded references in the electronic content to the embeddable external software element comprises supplying a handle associated with the electronic content, and wherein the electronic content is accessible to the software code using the handle;
providing an external software module;
detecting the processing of the electronic content; and
providing access to the electronic content by the external software module.

42. A system comprising:
means for providing an internal software module defining an embeddable internal software element;
means for providing a plurality of respective registries for different types of software elements, the plurality of respective registries comprising an embeddable software element registry for an externally defined embeddable external software element;
means for processing electronic content using the internal software module to resolve any embedded references in the electronic content to the embeddable internal software element and any embedded references in the electronic content to the embeddable external software element in the embeddable software element registry, wherein the embeddable external software element is supported by software code, wherein processing electronic content to resolve any embedded references in the electronic content to the embeddable external software element comprises supplying a handle associated with the electronic content, and wherein the electronic content is accessible to the software code using the handle;
means for providing an external software module;
means for detecting the processing of the electronic content; and
means for providing access to the electronic content by the external software module.
